(19) United States
(12) Patent Application Publication
(10) Pub. No.: US 2014/0090606 A1
(43) Pub. Date: Apr. 3, 2014

(54) USE AND GENERATION OF OZONE AS A DISINFECTANT OF DAIRY ANIMAL TISSUES, DAIRY EQUIPMENT, AND INFRASTRUCTURE

(71) Applicant: Agventures, LLC, Deming, NM (US)

(72) Inventor: Dana Heacox, Roswell, NM (US)

(73) Assignee: Agventures, LLC, Deming, NM (US)

(21) Appl. No.: 14/102,140

(22) Filed: Dec. 10, 2013

Related U.S. Application Data
(63) Continuation-in-part of application No. 13/183,826, filed on Jul. 15, 2011, now Pat. No. 8,609,120.
(60) Provisional application No. 61/364,498, filed on Jul. 15, 2010.

(51) Int. Cl. A01K 13/00

(52) U.S. Cl. CPC A01K 13/001
USPC 119/603

(57) ABSTRACT

An ozone delivery system, method, and apparatus are disclosed. Ozonated water can be used to disinfect and dean various surfaces, equipment, and animals in a dairy setting. Animals can be disinfected and protected from disease through the use of wash-pen and sprayer injections, and other footbath products. Ozone can be educted into a drop hose and a pre-dip line at periodic intervals and into a foot bath to provide refreshed ozonated water. The ozone delivery system and method sterilizes all equipment and floor surfaces without damaging diary equipment components. The system can incorporate computer-controlled options such as maintaining of gas levels, monitoring ozonated water levels, monitoring concentrations of ozone in said ozonated water, controlling entry and exit gates, controlling a drainage system, and monitoring and educting ozone in a foot bath and wash pen.

### CROSS REFERENCE TO RELATED APPLICATIONS

This patent application is a Continuation-in-Part of U.S. Non-Provisional Application No. 13/183,826, filed Jul. 5, 2011, entitled “USE AND GENERATION OF OZONE AS A DISINFECTANT OF DAIRY ANIMAL TISSUES, DAIRY EQUIPMENT, AND INFRASTRUCTURE,” which claims the benefit under 35 U.S.C. §119(e) of U.S. Provisional Application No. 61/364,498, filed on Jul. 15, 2010, and entitled “OZONE DELIVERY SYSTEM AND METHOD.” This patent application claims the benefit of the preceding applications. The disclosures of the preceding applications are all incorporated herein by reference in their entirety.

### FIELD OF THE INVENTION

The disclosed embodiments relate to dairy operations. The disclosed embodiments further relate to disinfecting dairy farm equipment. The disclosed embodiments also relate to using ozonated water to safely disinfect animals and equipment.

### BACKGROUND

With increased globalization of agricultural markets, greater demands are placed on producers of milk and milk products. Milk is produced as inexpensively as possible while conforming to high quality standards. Large quantities of milk are produced in automatic or semiautomatic milking plants.

Dairy milking systems can include a cluster of teat cups matched with flexible teat cup liners. The teat cups are attached to a teat of a dairy animal with a vacuum to facilitate movement of the flexible liner to milk the dairy animals. Milk flows from the dairy animal through each flexible liner and then through a short milk tube to a milker unit collecting bowl assembly, which collects milk from all of the animal's teats. Milk from individual animals flow from each collecting bowl assembly through a long milk tube and into a milk line that receives milk from all of the milker units in the dairy. The milk is then chilled and stored in a milk tank. The milk lines and storage systems must not be contaminated with dirt, debris, chemicals, pathogens, or contaminated milk. This milker unit can be used to milk cows, sheep, goats, and other dairy animals. Each milker unit can be used to milk multiple animals, thus necessitating sanitization measures to prevent transmission of dirt and bacteria into the milk and diseases transmitted between animals.

A dairy's somatic cell count (i.e., “SCC”) is correlated to the bacteria count in the final milk product. SCC levels are monitored to comply with state and federal milk quality standards. To avoid elevated SCC levels, dairies take disinfecting measures such as a teat pre-dip, for example. Broadened milk ducts in dairy animals' teats make the teats especially susceptible to infection from mastitis pathogens. The teats can be treated with a disinfectant solution, its application process known as pre-dipping. Prior automatic teat dip applicators and milker unit cleaner systems fail to adequately ensure that teat dip compositions and backflushing fluids do not enter the long milk tube and contaminate the dairy milk lines. Differential pressures between the milk lines, dipping, and backflushing devices can cause seepage into the milking system.

Accordingly, there exists a need for an ozone delivery system that uses ozonated water to safely disinfect dairy animal tissues, dairy equipment, and infrastructure and reduce the need for harmful chemical disinfectants around a dairy.

### SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is, therefore, an object of the disclosed embodiments to provide an improved disinfecting and cleaning system.

It is another object of the disclosed embodiments to disinfect animals and prevent disease.

It is an additional object of the disclosed embodiments to provide ozonated water to disinfect animals, equipment, and surfaces.

The above and other aspects can be achieved as is now described. An ozone delivery system, method, and apparatus are disclosed. Ozonated water can be used to disinfect and clean various surfaces, equipment, and animals in a dairy setting. Animals can be disinfected and protected from disease through the use of wash-pen and sprayer injections, and other footbath products. Ozone can be educted into a drop hose and a pre-dip line at periodic intervals and into a foot bath to provide refreshed ozonated water. The ozone delivery system and method sterilizes all equipment and floor surfaces without damaging diary equipment components. The system can incorporate computer-controlled options such as maintaining of gas levels, monitoring ozonated water levels, monitoring concentrations of ozone in said ozonated water, controlling entry and exit gates, controlling a drainage system, and monitoring and educting ozone in a foot bath and wash pen.

An ozone delivery system is disclosed herein. The system comprises: ozonated water comprising ozone dissolved at preferable concentrations of 0.04 parts per million to 2.1 parts per million, the ozone educted into a low-pressure hose and a pre-dip line with ozonated water; an ozone delivery apparatus comprising: a programmable logic controller and a relay for computer-controlled automation for educting ozone into the ozonated water, wherein the programmable logic controller turns off the ozone generator based on set parameters regarding pressure and ambient ozone level readings from a dissolved ozone meter; and a surface for applying the ozonated water for disinfecting and cleaning the surface through the application of the ozonated water to the surface through a low-pressure hose, wherein the surface comprises an exterior of an animal.

In an embodiment, the dissolved ozone meter reads and displays a concentration of the ozone in the ozonated water, wherein the programmable logic controller links a reading from the dissolved ozone meter to at least one of an alarm, an online monitoring system, a device to call a service technician, and a device to send a SMS message to the service technician. In another embodiment, the surface further comprises at least one of the following: a calf milk bottle, a washing machine used to wash teat wiping towel, an animal teat, an animal hoof, equipment, dairy equipment, a dairy surface, a floor surface, a dairy floor surface, an animal stall, a milking pit surface, and milking pit equipment.

In another embodiment, the disclosed ozone delivery system further comprises a foot bath filled with the ozonated water wherein an animal enters the foot bath to disinfect the animal in the ozonated water, wherein the foot bath comprises a service line that re-fills the foot bath with ozonated water, wherein the ozone is educted into a foot bath as controlled by an evac valve to provide refreshed ozonated water in the foot bath and clear the footbath of debris. In another embodiment, the system further comprises a wash pen utilizing the ozonated water wherein an animal enters the wash pen to disinfect the animal in the ozonated water, prevent dirt and bacteria from entering a milk supply, and prevent disease transmission between a plurality of animals. In other embodiments, the system comprises ozone educted into a drop hose and the pre-dip line at periodic intervals, wherein a fill valve is connected to the drop hose to periodically refresh the drop hose water and send water to the foot baths, based on a predetermined time cycle. In an embodiment, the ozone generator generates the ozonated water without mixing or storing the ozonated water in a reservoir, wherein the ozonated water comprising ozone is dissolved at a preferable concentration of 0.4 parts per million, wherein ozone is educted into a drop hose and the pre-dip line at periodic intervals. In other embodiments, the system further comprises the programmable logic controller coupled to an ozone generator, a pressure sensor, and the ambient gas detector.

In an embodiment, the system further comprises an automated valve managed by an ambient ozone gas detector, wherein the automated valve doses when ambient gas levels rise to within 80% of the OSHA eight hour exposure limit, and wherein the automated valve is opened for a preset amount of time when gas levels fall below 80% of the OSHA eight hour exposure limit. In another embodiment, the automated valve is programmed by the programmable logic controller to close based on an event, wherein the event comprises at least one of time of day, time of day when no cows are milked, time of day when milk line is washed. In other embodiments, the system further comprises a plurality of oxygen concentrators each coupled to a compressor, wherein a first oxygen contractor of the plurality of oxygen concentrators is turned on and off by a pressure switch located on an ozone tank, and wherein a second oxygen contractor of the plurality of oxygen concentrators is turned on and off by a pressure switch located on an inside manifold before a needle valve. In an embodiment, the system further comprises an enclosure housing the programmable logic controller, ozone generator, pressure sensor, needle valve, check valve, tank with pressure gauge, ball valve, automated valve, manifold, educator/injector, dissolved ozone meter, and light emitting diodes that signify unsafe ozone gas levels and machine power status, and wherein a thermal switch is located on an exterior of the enclosure, wherein the thermal switch measures external temperature, wherein the thermal switch indicates freezing temperatures to the programmable logic controller to modify filling and evacuating a footbath.

In yet another embodiment, an ozone delivery apparatus is disclosed. The apparatus comprises: ozonated water comprising ozone dissolved at preferable concentrations of 0.04 parts per million to 2.1 parts per million, the ozone educted into a low-pressure hose and a pre-dip line with ozonated water, the ozonated water exiting the low-pressure hose towards a surface wherein the surface is disinfected and cleaned via application of the ozonated water to the surface, wherein the surface comprises an exterior of an animal; and a programmable logic controller and a relay for computer-controlled automation for educting ozone into the ozonated water, wherein the programmable logic controller turns off the ozone generator based on set parameters regarding pressure and ambient ozone level readings from a dissolved ozone meter.

In an embodiment, the dissolved ozone meter reads and displays a concentration of the ozone in the ozonated water, wherein the programmable logic controller links a reading from the dissolved ozone meter to at least one of an alarm, an online monitoring system, a device to call a service technician, and a device to send a SMS message to the service technician. In another embedment, the apparatus further comprises an automated valve managed by an ambient ozone gas detector, wherein the automated valve closes when ambient gas levels rise to within 80% of the OSHA eight hour exposure limit, and wherein the automated valve is opened for a preset amount of time when gas levels fall below 80% of the OSHA eight hour exposure limit, wherein the automated valve is programmed by the programmable logic controller to dose based on an event, wherein the event comprises at least one of time of day, time of day when no cows are milked, time of day when milk line is washed. In yet another embodiment, the apparatus further comprises an enclosure housing the programmable logic controller, ozone generator, pressure sensor, needle valve, check valve, tank with pressure gauge, ball valve, automated valve, manifold, educator/injector, dissolved ozone meter, and light emitting diodes that signify unsafe ozone gas levels and machine power status, and wherein a thermal switch is located on an exterior of the enclosure, wherein the thermal switch measures external temperature, wherein the thermal switch indicates freezing temperatures to the programmable logic controller to modify filling and evacuating a footbath.

In another embodiment, an ozone delivery apparatus is disclosed. The apparatus comprises: ozonated water comprising ozone dissolved at preferable concentrations of 0.04 parts per million to 1.2 parts per million the ozone educted into a low-pressure hose and a pre-dip line with ozonated water, the ozonated water exiting the low-pressure hose towards a surface wherein the surface is disinfected and cleaned via application of the ozonated water to the surface, wherein the surface comprises an exterior of an animal; a programmable logic controller and a relay for computer-controlled automation for educting ozone into the ozonated water, wherein the programmable logic controller turns off the ozone generator based on set parameters regarding pressure and ambient ozone level readings from a dissolved ozone meter, wherein the programmable logic controller is coupled to an ozone generator, a pressure sensor, an ambient gas detector, and automated valves that feed and evacuate a foot bath, wherein the automated valves are cycled based on timing, water flow, or water level measurements; and the foot bath filled with water, wherein the ozone is educted into the foot bath, wherein an animal enters the foot bath to disinfect the animal in the ozonated water, wherein the foot bath comprises a service line that re-fills the foot bath with ozonated water, and wherein the animal is unsupported by a limb support mechanism.

In an embodiment, the dissolved ozone meter reads and displays a concentration of the ozone in the ozonated water, wherein the programmable logic controller links a reading from the dissolved ozone meter to at least one of an alarm, an online monitoring system, a device to call a service technician, and a device to send a SMS message to the service technician. In yet another embodiment, the apparatus further comprises an automated valve managed by an ambient ozone gas detector, wherein the automated valve closes when ambient gas levels rise to within 80% of the OSHA eight hour exposure limit, and wherein the automated valve is opened for a preset amount of time when gas levels fall below 80% of the OSHA eight hour exposure limit, wherein the automated valve is programmed by the programmable logic controller to dose based on an event, wherein the event comprises at least one of time of day, time of day when no cows are milked, time of day when milk line is washed. In another embodiment, the apparatus comprises an enclosure housing the programmable logic controller, ozone generator, pressure sensor, needle valve, check valve, tank with pressure gauge, ball valve, automated valve, manifold, educator/injector, dissolved ozone meter, and light emitting diodes that signify unsafe ozone gas levels and machine power status, and wherein a thermal switch is located on an exterior of the enclosure, wherein the thermal switch measures external temperature, wherein the thermal switch indicates freezing temperatures to the programmable logic controller to modify filling and evacuating a footbath.

### BRIEF DESCRIPTION OF THE FIGURES

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1A illustrates a block diagram of an ozone delivery system and apparatus, in accordance with a preferred embodiment;

FIG. 1B illustrates a block diagram of an ozone delivery system and apparatus, in accordance with a disclosed embodiment;

FIG. 2 illustrates a pictorial diagram of an exemplary dairy milking and disinfecting area, in accordance with the disclosed embodiments;

FIG. 3 illustrates a schematic view of a computer system in which the present invention may be embodied; and

FIG. 4 illustrates a schematic view of a software system including an operating system, application software, and a user interface for carrying out the present invention.

### DETAILED DESCRIPTION

The particular values and configurations discussed in these non-limiting examples can be varied and are cited merely to illustrate at least one embodiment and are not intended to limit the scope thereof.

The embodiments will now be described more fully hereinafter with reference to the accompanying drawings, in which illustrative embodiments of the invention are shown. The embodiments disclosed herein can be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

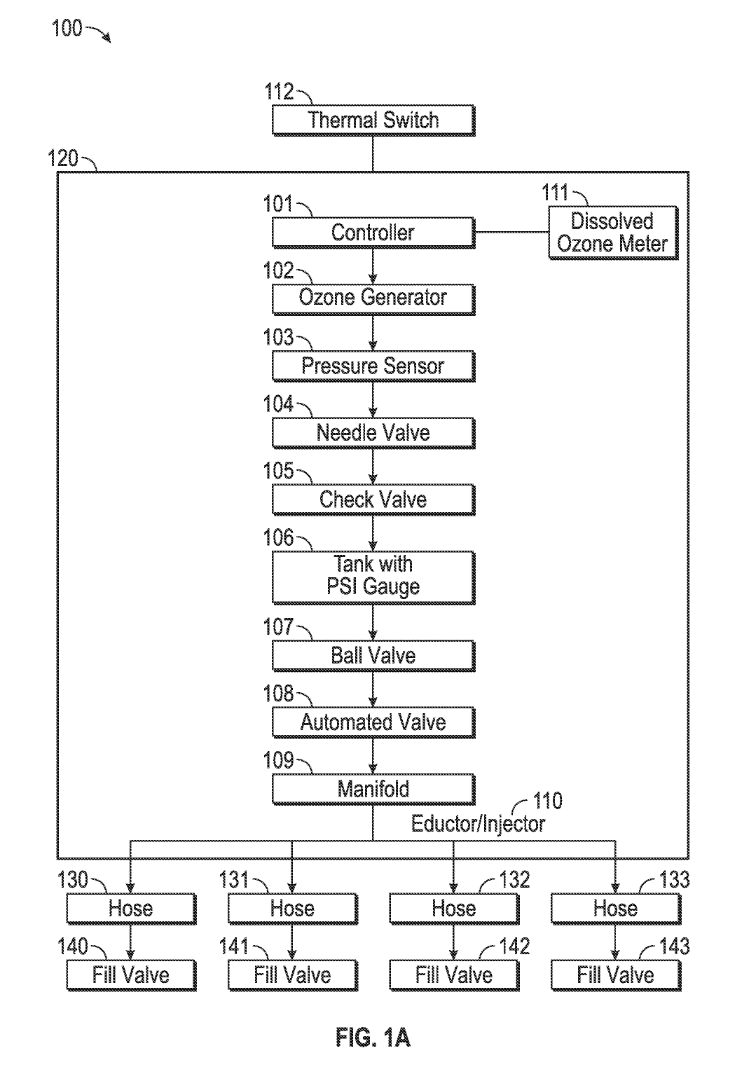

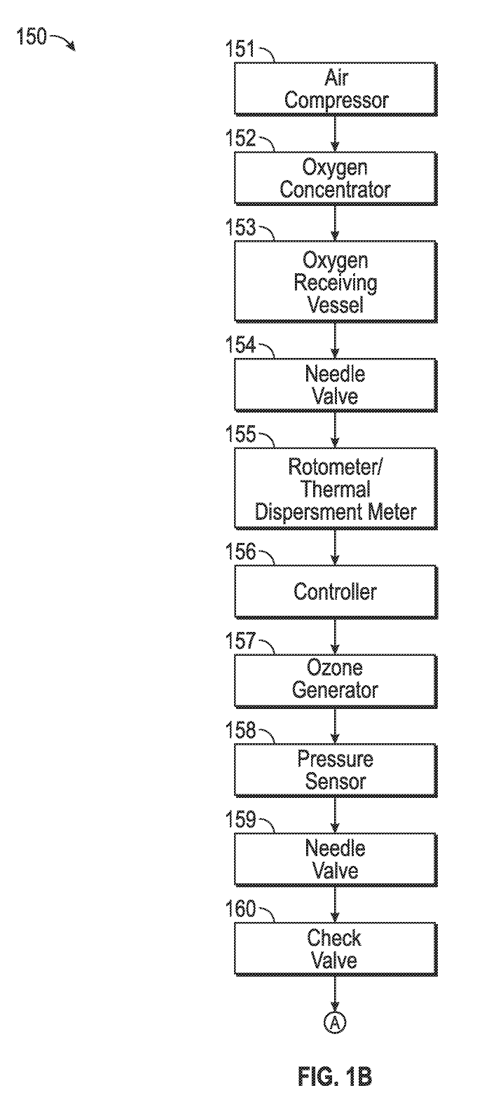

FIG. 1A illustrates a block diagram 100 of an ozone delivery system and apparatus, in accordance with the disclosed embodiments. The disclosed embodiments can include a system of a computer-controlled system for precise injected eduction to complement standard eduction processes. The ozone delivery system uses ozonated water mixed within the system in preferable concentration ranges from 0.04 ppm to 2.1 ppm (parts per million) depending on application to safely disinfect animals and equipment and reduce the need for harmful chemical disinfectants around a dairy, for example. A preferable concentration of ozonated water comprises ozone dissolved at a preferable concentration of 0.4 parts per million. Ozone is a powerful oxidizing agent. At appropriate usage levels, ozone is safe for humans and animals. The disclosed embodiments offset all expenses related to the purchase, storage, transportation, disposal and handling of disinfecting chemicals, e.g. insurance, facility space, chemical cost, etc. Because the system uses ozone, which degrades to oxygen, there is no environmental footprint to deal with nor hazardous chemicals to drain into the water supply. The disclosed embodiments can be utilized in the clean-in-place (“CIP”) process. In the CIP process, ozone is used to clean and disinfect milk lines.

The ozone delivery system can include a programmable logic controller 101 coupled or connected to an ozone generator 102, pressure sensor 103, and a dissolved ozone meter 111. The controller 101 may turn off the ozone generator 110 when certain levels of ozone are generated in the system. Pressure sensor 103 is connected to needle value 104 and check valve 105, Check valve 105 is connected to a tank with a pressure gauge 106. A ball valve 107 separates the tank 106 from an automated valve 108. Automated valve (“AV”) 108 is managed by an ambient ozone gas detector. When ambient gas levels rise to within 80% of the OSHA 8 hour exposure limit, the automated valve 108 is dosed. When gas levels fall below aforementioned level, the automated valve 108 is opened again after a preset amount of time (i.e., normally 3 minutes). This automated valve 108 can also be programmed by controller 101 to dose based on other events such as the time of day when no cows are being milked, or milk line are being washed, so as to conserve the ozone gas. An ambient ozone meter is also connected to the AV 108.

Automated value 108 is connected to manifold 109. The manifold 109 is then coupled to an edcutor/injector 110 with various output hoses 130, 131, 132, 133. Fill Valves 140, 141, 142, 143 are located at the end of the drop hose lines 130, 131, 132, 133, 134 and are time cycled to periodically refresh the drop hose water and send water to the foot baths. The controller 101 is also connected to the automated valves which feed the footbaths and evacuate the footbaths with the valves being cycled based on timing, water flow or water level measurements. Dissolved ozone meter (“DO”) 111 reads and displays the concentration of ozone in the water. This meter 111 can be linked to alarms, the programmable logic controller (PLC) 101, for online monitoring, or a device to call a service tech, or send the technician a SMS message.

Additionally, embodiments include two oxygen concentrators (“OC”) which possess their own compressors. One OC is turned on and off by a pressure switch located on the ozone tank (i.e., the main OC). One OC is turned on and off by a pressure switch located on the inside manifold before the needle valve (i.e., backup OC).

All components 101-111 are housed in a sealed air conditioned enclosure 120. Any fresh air that enters the machine must pass through a dessicant. The enclosure 120 also houses LEDs to signify safe and unsafe ozone gas levels, machine power status for the oxygen concentrators, and the ozone generator. Thermal Switch (“TS”) 112 is placed outside the enclosure 120 to measure temperature. If ambient temperatures fall below freezing, the TS 112 sends a signal to the controller 101 which is programmed to change the timing of the valves used to fill and evacuate the footbaths. This is in place to prevent freeze damage. Evacuation Valve(s) (“evac valves”) are located at the foot bath and are time cycled to periodically evacuate the foot bathes of spent ozone water and manure.

FIG. 1B illustrates a block diagram 150 of an alternate embodiment ozone delivery system and apparatus, in accordance with the disclosed embodiments. The ozone delivery system can include an air compressor 151 coupled to an oxygen concentrator 152, an oxygen receiving vessel 153, and a needle valve 154. An optional rotometer/thermal dispersment meter 155 can be coupled to a controller 156. The controller 156 is coupled to an ozone generator 157 and pressure sensor 158 as well as an ambient gas detector. The controller 156 may turn off the ozone generator 157 and/or close solenoid valves 162, 164 based on parameters set regarding pressure, ambient ozone levels, or any other preset parameters. The controller 156 is also connected to the automated valves which feed the footbaths and evacuate the footbaths with the valves being cycled based on timing, water flow or water level measurements. The pressure sensor 158 is coupled to a needle valve 159 and a check valve 160, The check valve 160 is coupled to a tank with a pressure gauge 161 and with an associated solenoid 162. The tank with a pressure gauge 161 is coupled to a ball valve 163, solenoid valve 164, check valve 165, and manifold 166. The manifold 166 is coupled to the eductor/injector 167 via a check valve and ball valve. Eductor/injector 167 has connected hoses 171, 172, 173, 174.

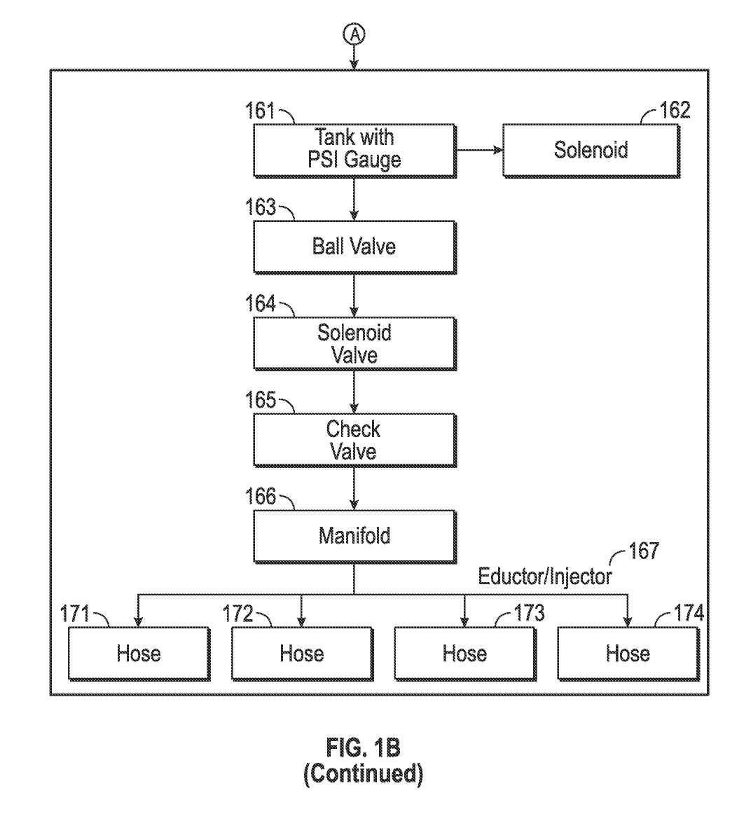

FIG. 2 illustrates a pictorial diagram 200 of an exemplary dairy milking and disinfecting area, in accordance with the disclosed embodiments. The disclosed ozone delivery system and method are designed to replace iodine pre-dip for teats and copper sulfate disinfectants. Both teats and hooves are disinfected and protected from disease through the use of wash-pen and sprayer injections, and/or other footbath products, filled with ozonated water. The ozone delivery system and method sterilizes all equipment and floor surfaces. Using ozonated water as a disinfectant does not damage the metal and/or plastic components of diary equipment. This system could potentially be used during the clean-in-place cleaning process.

An animal such as, for example, a cow can enter the wash pen 207 of a milking area 202. Ozonated water-filled drop hoses 205 spray ozone-saturated water to disinfect the equipment and floor surfaces in the pit. Animals and people surrounding the ozonated water-filled drop hoses do not risk exposure to a harmful mist of chemicals spraying from the drop hoses. The drop hoses closest to the breezeway 201 can optionally contain non-ozonated water for human consumption. Low pressure spray hoses 204 can be installed in the drop hose line 205 to spray teats with ozone-saturated water as a mastitis preventative pre-treatment. As the cow moves out of the milking area 202, the cow walks through an ozonated water-filled foot bath 206 to remove remaining fecal material and other soils from the hooves. The foot bath 206 can be equipped with an automatic drain to allow for quick draining of contaminated water and fecal material. The foot baths 206 can be periodically filled with ozone-saturated water. The footbath can periodically fill with fresh ozonated water through a service line connected to the drop hose line 205 for eduction of fresh ozone into drop hose 205 and pre-dip lines at periodic intervals, while simultaneously ‘topping-off’ foot baths 206 with fresh, educted ozone.

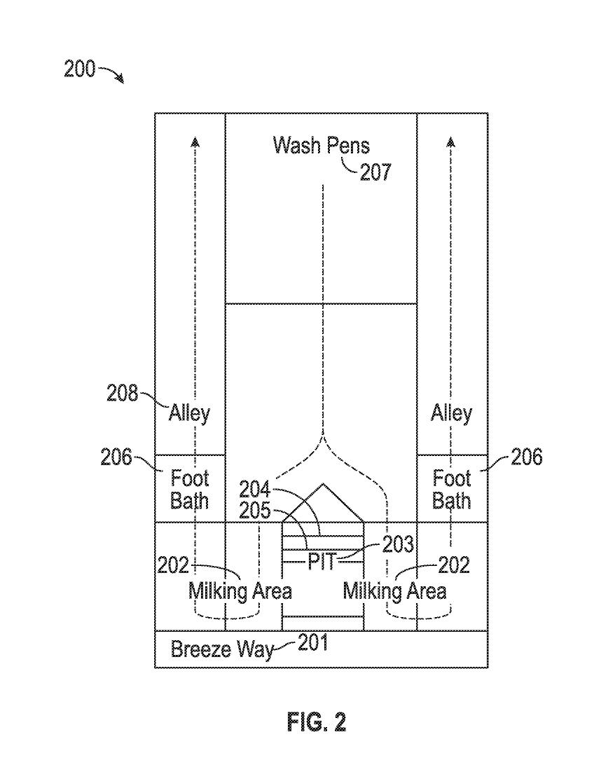

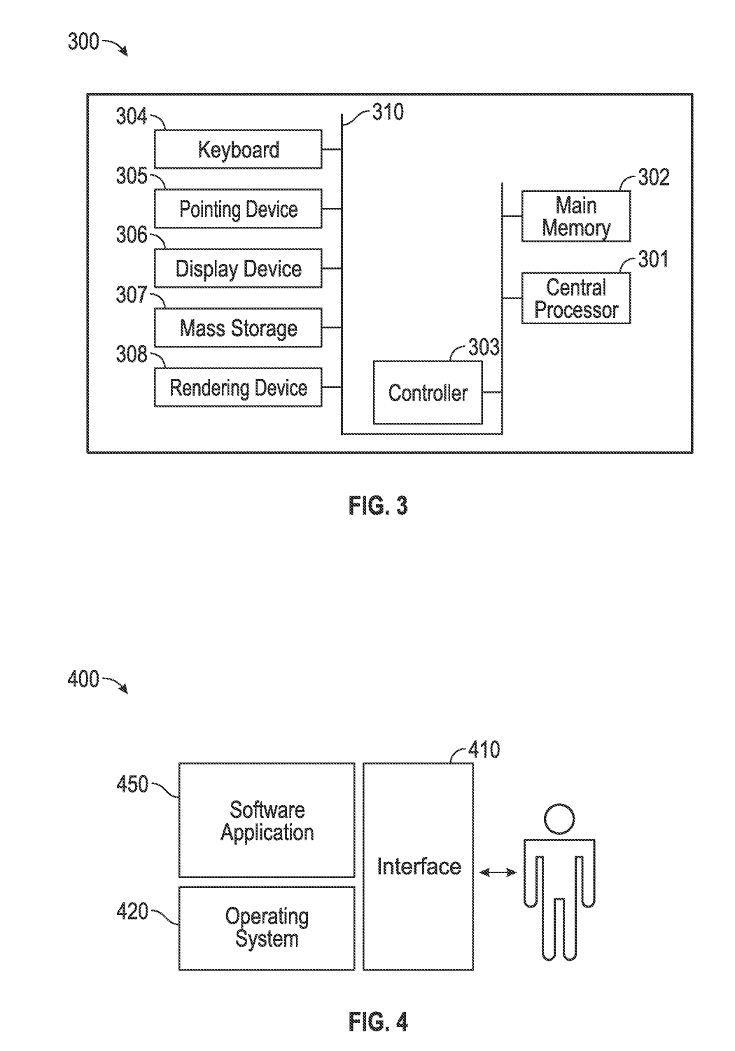

FIGS. 3-4 are provided as exemplary diagrams of data processing environments in which embodiments of the present invention may be implemented. It should be appreciated that FIGS. 3-4 are only exemplary and are not intended to assert or imply any limitation with regard to the environments in which aspects or embodiments of the present invention may be implemented. Many modifications to the depicted environments may be made without departing from the spirit and scope of the present invention.

As depicted in FIG. 3, the present invention may be embodied in the context of a data-processing apparatus 300 comprising a central processor 301, a main memory 302, an input/output controller 303, a keyboard 304, a pointing device 305 (e.g., mouse, track ball, pen device, or the like), a display device 306, and a mass storage 307 (e.g., hard disk). Additional input/output devices, such as a rendering device 308, may be included in the data-processing apparatus 300 as desired. The rendering device 308 may be a standalone single function device such as a dedicated printer, scanner, copy machine, etc. Preferably, rendering device 308 functions as a multifunction device capable of multiple rendering functions such as printing, copying, scanning, faxing, etc. As illustrated, the various components of the data-processing apparatus 300 communicate through a system bus 310 or similar architecture. The disclosed embodiments can also be controlled via a programmable logic controller (i.e., PLC) and relays.

A computer software system 400 for directing the operation of the data-processing apparatus 300 is depicted in FIG. 4. Software application 450, which is stored in main memory 302 and on mass storage 307, can include a kernel or operating system 420 and a shell or interface 410. One or more application programs such as application software 450 may be “loaded” (i.e., transferred from mass storage 307 into the main memory 302) for execution by the data-processing apparatus 300. The data-processing apparatus 300 thus can receive user commands and data through user interface 410. These inputs may then be acted upon by the data-processing apparatus 300 in accordance with instructions from operating module 420 and/or application module 450.

The interface 410, which is preferably a graphical user interface (e.g., GUI) or human machine interface (e.g., HMI), also serves to graphically display cleaning and disinfecting records, ozonated water levels, maintain and monitor concentration of ozone in water, entry and exit gates controls, drainage system controls, etc., whereupon a user may supply additional inputs or terminate a particular session. In one particular embodiment, operating system 420 and interface 410 can be implemented in the context of a “Windows” system. Application module 450, on the other hand, can include instructions such as the various operations described herein with respect to the various components and modules described herein such as, for example, the method 200 depicted in FIG. 2. Computer controls are also used to maintain gas levels within OSHA-permitted regulations to ensure worker safety.

It will be appreciated that variations of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

What is claimed is:

1. An ozone delivery system, comprising:
ozonated water comprising ozone dissolved at preferable concentrations of 0.04 parts per million to 2.1 parts per million, said ozone educted into a low-pressure hose and a pre-dip line with ozonated water;
an ozone delivery apparatus comprising:
a programmable logic controller and a relay for computer-controlled automation for educting ozone into said ozonated water, wherein said programmable logic controller turns off said ozone generator based on set parameters regarding pressure and ambient ozone level readings from a dissolved ozone meter; and
a surface for applying said ozonated water for disinfecting and cleaning said surface through said application of said ozonated water to said surface through a low-pressure hose, wherein said surface comprises an exterior of an animal.

2. The system of claim 1 wherein said dissolved ozone meter reads and displays a concentration of said ozone in said ozonated water, wherein said programmable logic controller links a reading from said dissolved ozone meter to at least one of an alarm, an online monitoring system, a device to call a service technician, and a device to send a SMS message to said service technician.

3. The system of claim 1 wherein said surface further comprises at least one of the following: a calf milk bottle, a washing machine used to wash teat wiping towel, an animal teat, an animal hoof, equipment, dairy equipment, a dairy surface, a floor surface, a dairy floor surface, an animal stall, a milking pit surface, and milking pit equipment.

4. The system of claim 1 further comprising a foot bath filled with said ozonated water wherein an animal enters said foot bath to disinfect said animal in said ozonated water, wherein said foot bath comprises a service line that re-fills said foot bath with ozonated water, wherein said ozone is educted into a foot bath as controlled by an evac valve to provide refreshed ozonated water in said foot bath and clear said footbath of debris.

5. The system of claim 1 further comprising a wash pen utilizing said ozonated water wherein an animal enters said wash pen to disinfect said animal in said ozonated water, prevent dirt and bacteria from entering a milk supply, and prevent disease transmission between a plurality of animals.

6. The system of claim 1 further comprising ozone educted into a drop hose and said pre-dip line at periodic intervals, wherein a fill valve is connected to said drop hose to periodically refresh water in said drop hose and send water to a foot bath based on a predetermined time cycle.

7. The system of claim 1 wherein said ozone generator generates said ozonated water without mixing or storing said ozonated water in a reservoir, wherein said ozonated water comprising ozone is dissolved at a preferable concentration of 0.4 parts per million, wherein ozone is educted into a drop hose and said pre-dip line at periodic intervals.

8. The system of claim 1 further comprising said programmable logic controller coupled to an ozone generator, a pressure sensor, and said ambient gas detector.

9. The system of claim 1 further comprising an automated valve managed by an ambient ozone gas detector, wherein said automated valve closes when ambient gas levels rise to within 80% of an OSHA eight hour exposure limit, and wherein said automated valve is opened for a preset amount of time when gas levels fall below 80% of said OSHA eight hour exposure limit.

10. The system of claim 9 wherein said automated valve is programmed by said programmable logic controller to close based on an event, wherein said event comprises at least one of time of day, time of day when no cows are milked, time of day when milk line is washed.

11. The system of claim 1 further comprising a plurality of oxygen concentrators each coupled to a compressor, wherein a first oxygen contractor of said plurality of oxygen concentrators is turned on and off by a pressure switch located on an ozone tank, and wherein a second oxygen contractor of said plurality of oxygen concentrators is turned on and off by a pressure switch located on an inside manifold before a needle valve.

12. The system of claim 1 further comprising an enclosure housing said programmable logic controller, ozone generator, pressure sensor, needle valve, check valve, tank with pressure gauge, ball valve, automated valve, manifold, educator/injector, dissolved ozone meter, and light emitting diodes that signify unsafe ozone gas levels and machine power status, and wherein a thermal switch is located on an exterior of said enclosure, wherein said thermal switch measures external temperature, wherein said thermal switch indicates freezing temperatures to said programmable logic controller to modify filling and evacuating a footbath.

13. An ozone delivery apparatus, comprising:
ozonated water comprising ozone dissolved at preferable concentrations of 0.04 parts per million to 2.1 parts per million, said ozone educted into a low-pressure hose and a pre-dip line with ozonated water, said ozonated water exiting said low-pressure hose towards a surface wherein said surface is disinfected and cleaned via application of said ozonated water to said surface, wherein said surface comprises an exterior of an animal; and
a programmable logic controller and a relay for computer-controlled automation for educting ozone into said ozonated water, wherein said programmable logic controller turns off said ozone generator based on set parameters regarding pressure and ambient ozone level readings from a dissolved ozone meter.

14. The apparatus of claim 13 wherein said dissolved ozone meter reads and displays a concentration of said ozone in said ozonated water, wherein said programmable logic controller links a reading from said dissolved ozone meter to at least one of an alarm, an online monitoring system, a device to call a service technician, and a device to send a SMS message to said service technician.

15. The apparatus of claim 13 further comprising an automated valve managed by an ambient ozone gas detector, wherein said automated valve closes when ambient gas levels rise to within 80% of an OSHA eight hour exposure limit, and wherein said automated valve is opened for a preset amount of time when gas levels fall below 80% of said OSHA eight hour exposure limit, wherein said automated valve is programmed by said programmable logic controller to close based on an event, wherein said event comprises at least one of time of day, time of day when no cows are milked, time of day when milk line is washed.

16. The apparatus of claim 13 further comprising an enclosure housing said programmable logic controller, ozone generator, pressure sensor, needle valve, check valve, tank with pressure gauge, ball valve, automated valve, manifold, educator/injector, dissolved ozone meter, and light emitting diodes that signify unsafe ozone gas levels and machine power status, and wherein a thermal switch is located on an exterior of said enclosure, wherein said thermal switch measures external temperature, wherein said thermal switch indicates freezing temperatures to said programmable logic controller to modify filling and evacuating a footbath.

17. An ozone delivery apparatus, comprising:
ozonated water comprising ozone dissolved at preferable concentrations of 0.04 parts per million to 1.2 parts per million said ozone educted into a low-pressure hose and a pre-dip line with ozonated water, said ozonated water exiting said low-pressure hose towards a surface wherein said surface is disinfected and cleaned via application of said ozonated water to said surface, wherein said surface comprises an exterior of an animal;
a programmable logic controller and a relay for computer-controlled automation for educting ozone into said ozonated water, wherein said programmable logic controller turns off said ozone generator based on set parameters regarding pressure and ambient ozone level readings from a dissolved ozone meter, wherein said programmable logic controller is coupled to an ozone generator, a pressure sensor, an ambient gas detector, and automated valves that feed and evacuate a foot bath, wherein said automated valves are cycled based on timing, water flow, or water level measurements; and
said foot bath filled with water, wherein said ozone is educted into said foot bath, wherein an animal enters said foot bath to disinfect said animal in said ozonated water, wherein said foot bath comprises a service line that re-fills said foot bath with ozonated water, and wherein said animal is unsupported by a limb support mechanism.

18. The apparatus of claim 17 wherein said dissolved ozone meter reads and displays a concentration of said ozone in said ozonated water, wherein said programmable logic controller links a reading from said dissolved ozone meter to at least one of an alarm, an online monitoring system, a device to call a service technician, and a device to send a SMS message to said service technician.

19. The apparatus of claim 17 further comprising an automated valve managed by an ambient ozone gas detector, wherein said automated valve closes when ambient gas levels rise to within 80% of an OSHA eight hour exposure limit, and wherein said automated valve is opened for a preset amount of time when gas levels fall below 80% of said OSHA eight hour exposure limit, wherein said automated valve is programmed by said programmable logic controller to close based on an event, wherein said event comprises at least one of time of day, time of day when no cows are milked, time of day when milk line is washed.

20. The apparatus of claim 17 further comprising an enclosure housing said programmable logic controller, ozone generator, pressure sensor, needle valve, check valve, tank with pressure gauge, ball valve, automated valve, manifold, educator/injector, dissolved ozone meter, and light emitting diodes that signify unsafe ozone gas levels and machine power status, and wherein a thermal switch is located on an exterior of said enclosure, wherein said thermal switch measures external temperature, wherein said thermal switch indicates freezing temperatures to said programmable logic controller to modify filling and evacuating a footbath.
